(19) United States
(12) Patent Application Publication
(10) Pub. No.: US 2024/0328008 A1
(43) Pub. Date: Oct. 3, 2024

(54) METHOD OF PRODUCING HETEROJUNCTION MATERIAL FOR MEXENE OF METAL PHOSPHIDE AND METAL CARBIDE AND ELECTROCATALYST COMPOSITE USING THE SAME

(71) Applicant: RESEARCH & BUSINESS FOUNDATION SUNGKYUNKWAN UNIVERSITY, Suwon-si (KR)

(72) Inventors: Jung Kyu KIM, Suwon-si (KR); Jun Young LEE, Suwon-si (KR); Seung Hun ROH, Suwon-si (KR)

(73) Assignee: RESEARCH & BUSINESS FOUNDATION SUNGKYUNKWAN UNIVERSITY, Suwon-si (KR)

(21) Appl. No.: 18/405,186

(22) Filed: Jan. 5, 2024

(30) Foreign Application Priority Data
Jan. 6, 2023 (KR) 10-2023-0002490

(51) Int. Cl. C25B 11/054; C25B 11/091

(52) U.S. Cl. CPC C25B 11/054; C25B 11/091

(57) ABSTRACT

An embodiment of the disclosure provides an electrochemical catalyst composite and a method of producing the same. The electrochemical catalyst composite according to an embodiment of the disclosure is a hybrid material having a heterojunction structure between metal phosphide with controlled crystal strain and the MXene, in which metal phosphide produced by a synergy effect between the two materials prevents an overlapping phenomenon caused by the van der Waals force of the two-dimensional MXene material and increases a surface area, thereby having an effect on increasing reaction active points. Further, metal phosphide material with the controlled strain causes an electron structure of an element in the MXene support to be rearranged, thereby inducing change in an electrical structure. In addition, the MXene support combined with metal phosphide having the controlled strain promotes a hydrogen generation reaction, thereby having effects on enhancing the electrochemical performance and improving the electrical properties and stability of the material.

### CROSS REFERENCE TO RELATED APPLICATION

The present application claims priority to Korean Patent Application No. 10-2023-0002490, filed Jan. 6, 2023, the entire contents of which are incorporated herein for all purposes by this reference.

### BACKGROUND OF THE INVENTION

### Field of the Invention

The present invention relates to an electrochemical catalyst composite.

### Description of the Related Art

Carbon dioxide excessively generated by excessive use of fossil fuels is causing global environmental pollution such as global warming.

To solve this, a hydrogen fuel, i.e., an eco-friendly energy source is being proposed as an alternative fuel, and an electrochemical production method, i.e., a method of using a zero-carbon process to produce the hydrogen fuel is being actively researched as recognized for its potential.

In this case, an electrocatalyst is essential to activate an electrochemical reaction, and materials based on rare metals such as platinum, palladium, iridium, and ruthenium have been conventionally used as catalyst materials.

Although the rare metal-based materials have an advantage of high electrochemical performance, they have a problem of being difficult to commercialize due to their uneconomical characteristics and a problem of low stability due to dissociation during reaction in electrolyte.

To replace such rare metal-based materials, materials based on non-metals have been studied, but their performance has not met expectations.

Accordingly, many challenges still remain to develop catalyst materials excellent in electrochemical performance without using precious metal-based materials.

### SUMMARY OF THE INVENTION

An aspect of the disclosure is to provide an electrochemical catalyst composite, which contains a two-dimensional MXene support and metal phosphide nanoparticles with controlled crystal strain at surface defects of the Mxene support, and a method of producing the same.

Technical problems to be solved in the disclosure are not limited to the forementioned technical problems, and other unmentioned technical problems can be clearly understood from the following description by a person having ordinary knowledge in the art to which the disclosure pertains.

To solve the technical problems, there is provided an electrochemical catalyst composite according to an embodiment of the disclosure.

According to an embodiment of the disclosure, the electrochemical catalyst composite may include a two-dimensional MXene support with surface defects; and metal phosphide nanoparticles located at a surface defect site of the two-dimensional MXene support and having controlled crystal strain.

Further, according to an embodiment of the disclosure, the two-dimensional MXene support with the surface defects and metal phosphide nanoparticles may be heterogeneously bonded.

Further, according to an embodiment of the disclosure, the two-dimensional MXene support with the surface defects may include metal carbide MXenes represented by the following chemical formula 1.

M₃C₂Tₓ [Chemical formula 1]

where M is one or more metals selected from the group consisting of Ti, V, Cr, Zr, Nb, Mo, Hf, Ta and Sc, T is a functional group of F, O or OH, and x is a real number greater than 0.

Further, according to an embodiment of the disclosure, the two-dimensional MXene support may be subjected to an ultrasonic dispersion process in an acidic solution and an organic solution to have the surface defects.

Further, according to an embodiment of the disclosure, metal phosphide may include one or more selected from the group consisting of nickel phosphide, iron phosphide, titanium phosphide, manganese phosphide, copper phosphide, molybdenum phosphide, and cobalt phosphide.

Further, according to an embodiment of the disclosure, metal phosphide may be contained by 30 wt % to 40 wt % relative to the total weight of the electrochemical catalyst composite.

To solve the technical problems, there is provided a method of producing an electrochemical catalyst composite according to another embodiment of the disclosure.

The method of producing the electrochemical catalyst composite according to an embodiment of the disclosure my include the steps of preparing a two-dimensional MXene support by selectively removing an aluminum layer from a two-dimensional MAX material; forming defects on the surface of the two-dimensional MXene support by subjecting the MXene support to an ultrasonic dispersion process; and producing the electrochemical catalyst composite by forming metal phosphide nanoparticles, of which crystal strain is controlled, in a surface defect site of the MXene support through heteronuclear growth based on a hot injection method in the two-dimensional MXene support with the surface defects.

Further, according to an embodiment of the disclosure, in the step of preparing the two-dimensional MXene support, the two-dimensional MAX material may include materials represented by the following chemical formula 2.

Mₙ₊₁AXₙ [Chemical formula 2]

where M is one or more metals selected from the group consisting of Ti, V, Cr, Zr, Nb, Mo, Hf, Ta and Sc, A is one or more metals selected from the group consisting of Al, Si, P, S, Ga, Ge, As, Cd, In, Sn, Ti and Pb, X is C or N, and n is a natural number greater than or equal to 1.

Further, according to an embodiment of the disclosure, in the step of preparing the two-dimensional MXene support, the two-dimensional MXene support may include metal carbide MXenes represented by the following chemical formula 1.

M₃C₂Tₓ [Chemical formula 1]

where M is one or more metals selected from the group consisting of Ti, V, Cr, Zr, Nb, Mo, Hf, Ta and Sc, T is a functional group of F, O or OH, and x is a real number greater than 0.

Further, according to an embodiment of the disclosure, in the step of forming the defects on the surface of the MXene support, the ultrasonic dispersion process may be performed in two stages in an acidic solution and an organic solvent.

### BRIEF DESCRIPTION OF THE DRAWINGS

FIG. 1 is a schematic diagram showing an electrochemical catalyst composite according to an embodiment of the disclosure.

FIG. 2 is a flowchart showing a method of producing an electrochemical catalyst composite according to an embodiment of the disclosure.

FIG. 3 shows a scanning electron microscopy (SEM) image of an electrochemical catalyst composite according to an embodiment of the disclosure.

FIG. 4 shows a low-magnification transmission electron microscopy (TEM)image of an electrochemical catalyst composite according to an embodiment of the disclosure.

FIG. 5 shows high-angle annular dark field scanning transmission electron microscopy (HAADF-STEM) images of an electrochemical catalyst composite according to an embodiment of the disclosure and elemental energy dispersive spectroscopy (EDS) mapping images of P, Ni, C, and Ti.

FIG. 6 shows a TEM image where Ni₂P is produced on the MXene of an electrochemical catalyst composite according to an embodiment of the disclosure.

FIG. 7 shows fast Fourier transformation (FFT) and TEM images of an electrochemical catalyst composite according to an embodiment of the disclosure.

FIG. 8 shows a TEM image of a Ni₂P material.

FIG. 9 shows X-ray photoelectron spectroscopy (XPS) spectra of Ni₂P, MXene, and electrochemical catalyst composite (Ni₂P@MXene) materials, especially FIG. 9A shows Ni₂P, FIG. 9B shows P 2p, FIG. 9C shows Ti 2p, and FIG. 9D shows C 1s.

FIG. 10 shows graphs of electrochemical performances of electrochemical catalyst composites, especially FIG. 10A shows hydrogen generation electrochemical reaction performance of catalyst materials, FIG. 10B shows Tafel slope by catalyst material, FIG. 10C shows cyclic current voltage graph according to scan rate, and FIG. 10D shows double layer capacitances by material extracted from cyclic current voltage data.

FIG. 11A shows an electrochemical performance change graph and FIG. 11B shows electrochemical impedance experimental data after an electrochemical catalyst composite is subjected to 2,000 cyclic voltammetry operations.

### DETAILED DESCRIPTION OF THE INVENTION

Hereinafter, the disclosure will be described with reference to the accompanying drawings. However, the disclosure may be implemented in various different forms, and is not limited to the embodiments described herein. In the drawings, parts unrelated to the description are omitted to clearly describe the disclosure, and like numerals refer to like components throughout the specification.

Throughout the specification, when a part is referred to as being “connected (accessed, contacted, coupled)” to another part, not only it can be “directly connected” to the other part but it can also be “indirectly connected” to the other part via an intervening member. Further, when a certain part is referred to as “including” a certain component, this indicates that other components are not excluded but may be additionally included uncles otherwise noted.

The terms used in this specification are only used to describe specific embodiments, but not intended to limit the disclosure. Unless the context clearly dictates otherwise, singular forms include plural forms as well. In this specification, “it should be understood that term “include” or “have” indicates that a feature, a number, a step, an operation, a component, a part, or the combination thereof described in the embodiments is present, but does not preclude a possibility of presence or addition of one or more other features, numbers, steps, operations, components, parts or combinations thereof, in advance.

Below, the embodiments of the disclosure will be described in detail with reference to the accompanying drawings.

An electrochemical catalyst composite will be described according to an embodiment of the disclosure.

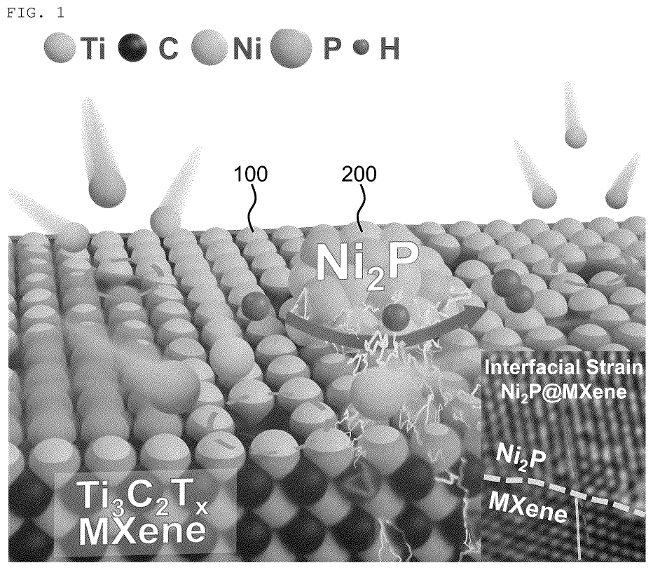

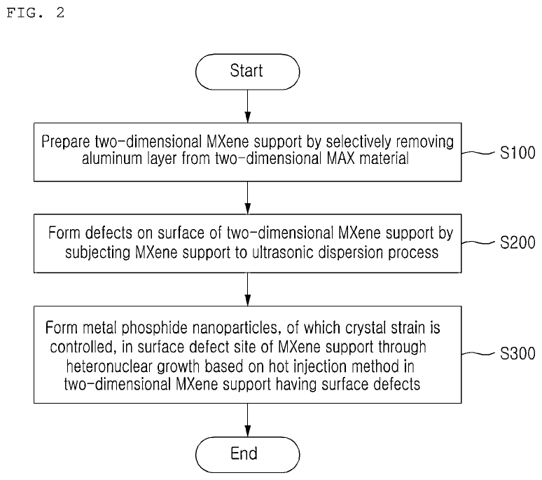

FIG. 1 is a schematic diagram showing an electrochemical catalyst composite according to an embodiment of the disclosure.

Referring to FIG. 1, the electrochemical catalyst composite according to an embodiment of the disclosure may include a two-dimensional MXene support with surface defects; and metal phosphide nanoparticles located at a surface defect site of the two-dimensional MXene support and having controlled crystal strain.

Further, the two-dimensional MXene support with the surface defects and metal phosphide nanoparticles may be heterogeneously bonded.

A catalyst material conventionally used in an electrochemical reaction to produce hydrogen in water electrolysis is uneconomical because it is based on rare metals such as platinum, palladium, iridium, and ruthenium, and has a problem of low stability because the material is dissociated during reaction in electrolyte. To solve the foregoing problems, an aspect of the disclosure is aimed at producing an electrochemical catalyst based on non-metals.

First, according to the disclosure, the two-dimensional MXene support with the surface defects may be prepared.

According to the disclosure, MXene, i.e., a material based on a transition metal carbide excellent in conductivity may be used as a support to overcome the uneconomical characteristics of the catalyst materials based on precious metals and produce a catalyst material which can be commercialized through process scale-up.

A MXene refers to a material that has a chemical composition consisting of a transition metal and nitrogen or carbon and of which two-dimensional molecules have a planar shape. The MXene is attracting attention as a unique material that is excellent in physical durability and electrical conductivity and is hydrophilic due to hydroxyl group or oxygen present at the end.

In this case, according to the disclosure, the surface defects are intentionally formed in the MXene support, and metal phosphide nanoparticles are grown on the surface defect site of the MXene support where the surface defects are induced, so that the two-dimensional MXene material can be prevented from an overlapping phenomenon to increase a surface area, thereby increasing active points for a catalyst reaction.

In this case, the two-dimensional MXene support with the surface defects used according to the disclosure may include titanium carbide MXenes (Ti₃C₂Tₓ, where Tₓ is the functional group of F, O, and OH). However, MXene compounds having various compositions depending on transition metals may be used without limitation, and the MXene compounds may be represented by M₃C₂Tₓ.

In this case, M may include Ti, V, Cr, Zr, Nb, Mo, Hf, Ta or Sc, and Tₓ may include the functional group of F, O or OH.

For example, Ti₃C₂Tₓ, Mo₃C₂Tₓ or Zr₃C₂Tₓ may be used.

Further, according to the disclosure, the surface defects of the two-dimensional MXene support may be formed by performing the ultrasonic dispersion process in the acidic solution and the organic solution.

A method of forming the surface defects in the MXene support will be described in detail in the following description about the method of producing the electrochemical catalyst composite.

Further, the electrochemical catalyst composite according to an embodiment of the disclosure may include metal phosphide nanoparticles.

In this case, metal phosphide nanoparticles are located at the surface defect site of the two-dimensional MXene support, and have the controlled crystal strain.

In this case, metal phosphide may be synthesized in the surface defect site of the two-dimensional MXene support by the heteronuclear growth based on a hot injection method.

With this, an electrochemical catalyst composite hybrid material (Me-P@MXene) may be developed to have a heterojunction structure of the MXene and metal phosphide having a crystalline structure of which strain is controlled.

For example, when nickel phosphide (Ni₂P) is used among metal phosphide materials, nickel phosphide (Ni₂P) is heterogeneously grown on the MXene support intentionally subjected to a defect process to create the active points, thereby forming the nanoparticles of which the crystal strain is controlled.

In this case, nickel phosphide (Ni₂P) formed at the defect active points may implement a spherical shape with a hollow center due to the crystal strain, and cause change in the electronic structure properties of the MXene support, thereby rearranging the electronic structure.

In this case, in the electrochemical catalyst composite according to an embodiment of the disclosure, a chemical bond between Ni of nickel phosphide and C of the MXene support may be formed by the hot injection method, and the electronic structure may be rearranged by the bond between Ni and C.

In this case, the electrochemical catalyst composite having the rearranged electronic structure may be increased in an electron transfer efficiency, in which the electrons are transferred from Ni of nickel phosphide to the MXene support.

In this case, metal phosphide may include one or more selected from the group consisting of nickel phosphide, iron phosphide, titanium phosphide, manganese phosphide, copper phosphide, molybdenum phosphide and cobalt phosphide.

Metal phosphide is not limited to the foregoing examples as long as it contains the transition metal and phosphorus.

Further, according to the disclosure, metal phosphide contained in the electrochemical catalyst composite by 30 wt % to 40 wt % relative to the total weight of the electrochemical catalyst composite.

In this case, if the content of metal phosphide is less than 30 wt % relative to the total weight of the electrochemical catalyst composite, the active points for a hydrogen evolution reaction (HER) are reduced, thereby lowering an efficiency. On the other hand, if the content is more than 40 wt %, metal phosphide covers the MXene support, thereby lowering the reaction efficiency. Thus, metal phosphide may be contained by 30 wt % to 40 wt %.

Further, the electrochemical catalyst composite according to an embodiment of the disclosure has an excellent hydrogen reduction reaction in the acidic solution due to the MXene support and the controlled crystal strain of metal phosphide.

Although metal phosphide based on non-precious metals has been developed as a catalyst for the HER because it is excellent due to high reactivity when crystals on the (001) surface are revealed, the material itself has low electrical conductivity and low persistence, thereby causing a problem of lowering the electrocatalytic activity efficiency of metal phosphide (e.g., Ni₂P).

To overcome such limitations of metal phosphide, the electrochemical catalyst composite according to an embodiment of the disclosure combines metal phosphide with a highly conductive substrate made of carbon nanotubes (CNT), carbon cloth, carbon paper, or graphene, thereby enabling faster electron transport.

According to another embodiment of the disclosure, a method of producing an electrochemical catalyst composite will be described.

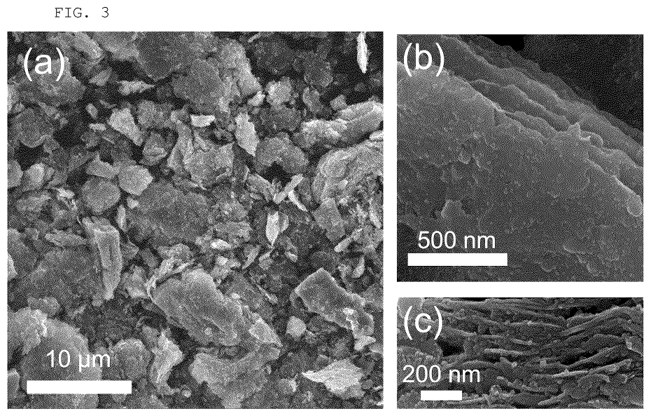

FIG. 2 is a flowchart showing a method of producing an electrochemical catalyst composite according to an embodiment of the disclosure.

Referring to FIG. 2, the method of producing the electrochemical catalyst composite according to an embodiment of the disclosure may include the steps of preparing a two-dimensional MXene support by selectively removing an aluminum layer from a two-dimensional MAX material (S100); forming defects on the surface of the two-dimensional MXene support by subjecting the MXene support to an ultrasonic dispersion process (S200); and forming metal phosphide nanoparticles, of which crystal strain is controlled, in a surface defect site of the MXene support through heteronuclear growth based on a hot injection method in the two-dimensional MXene support with the surface defects (S300).

In the first step, the two-dimensional MXene support is prepared by selectively removing the aluminum layer from the two-dimensional MAX material (S100).

MAX phases have a chemical formula Mₙ₊₁AXₙ, where M is a transition metal, A is an element from the group 13 or 14, and X is carbon or nitrogen, which are abbreviated as MAX in the form of the chemical formula.

For example, M may include Ti, V, Cr, Zr, Nb, Mo, Hf, Ta or Sc.

For example, A may include Al, Si, P, S, Ga, Ge, As, Cd, In, Sn, Ti or Pb.

The MAX phases have a layered structure with ductility to be mechanically machined even though they are ceramic materials, and are excellent in thermal and electrical conductivity.

In the MAX phase material according to an embodiment of the disclosure, M may include Ti, V, Cr, Zr, Nb, Mo, Hf, Ta or Sc, and A may include Al, Si, P, S, Ga, Ge, As, Cd, In, Sn, Ti or Pb.

The nitride-based MAX phase may be treated in the acidic solution to selectively etch an Al element layer. A method of selectively etching the Al element layer may include the steps of preparing the acidic solution by mixing HCl and KF powder; and selectively etching the AI element layer as Tiₙ₊₁AlXₙ MAX phase powder is added with the acidic solution, left for 3 hours at room temperature, and subjected to an ultrasonic process, thereby producing nitride-based MXenes of Ti₂N.

In this case, the acidic solution may include HCl or HF, and may further include one or more selected from KF and LiF. However, the acidic solution is not limited to the foregoing acidic substances.

The reason why the acidic solution further includes KF or LiF is because it may help to further delaminate a MXene layer during the subsequent ultrasonic process and prevent restacking during the etching.

For example, the Al element layer is selectively etched from the MAX phase (Ti₃AlC₂), thereby producing a MXene sheet having a two-dimensional planar structure similar to the graphene.

In the second step, the defects are formed on the surface of the two-dimensional MXene support by subjecting the MXene support to the ultrasonic dispersion process (S200).

The two-dimensional MXene support may be subjected to the ultrasonic process to promote the delamination of the MXene support.

Further, according to the disclosure, the MXene support is first dispersed in an acidic aqueous solution through the ultrasonic process, thereby delaminating the two-dimensional MXene support.

For example, for the process of forming the defects in the MXene, 100 mg of multilayered MXene may be dispersed forming the surface defects as being subjected to the ultrasonic process in 10 mL of the acidic aqueous solution (mixture of 40% H₂SO₄ and 20% HNO₃ by volume) for 30 minutes.

In addition, the MXene support, which has been dispersed and delaminated forming the surface defects in the acidic aqueous solution, may be further dispersed as being put into an organic solvent and subjected to the ultrasonic process.

For example, the MXene may be redispersed in dimethyl sulfoxide (DMSO), and subjected to the ultrasonic process for 36 hours under Ar gas atmosphere.

In this case, the surface defects may be formed in the acidic solution by the ultrasonic process.

Thus, the MXene support with surface active points based on the surface defects was prepared.

In the third step, metal phosphide nanoparticles, of which the crystal strain is controlled, are formed in a surface defect site of the MXene support through the heteronuclear growth based on the hot injection method in the two-dimensional MXene support with the surface defects (S300).

In this case, a method of forming metal phosphide nanoparticles, of which the crystal strain is controlled, in the surface defect site of the MXene support may include the steps of heating Ni(acac)₂, oleylamine, and octadecene together with the MXene support, which has the active points based on the surface defects, up to 120° C. while raising temperature by 10° C. per minute; adding tri-n-octylphosphine, heating up to 320° C. for reaction, and then cooling slowly; and washing after obtaining a precipitate.

In this case, the reason why the MXene with the surface defects is subjected to the hot injection process for the heteronuclear growth of the nanoparticles is because the hot injection process is a process suitable for effective nuclear growth of the nanoparticles at the active points, i.e., the defect points of the MXene support.

In this way, the electrochemical catalyst composite according to an embodiment of the disclosure may be formed with metal phosphide nanoparticles, of which the crystal strain is controlled, in the surface defect site of the MXene support by the heteronuclear growth on the two-dimensional MXene support.

In this case, nickel phosphide (Ni₂P) formed at the defect active points may implement the spherical shape with the hollow center due to the crystal strain, and cause change in the electronic structure properties of the MXene support, thereby rearranging the electronic structure.

In this case, the electrochemical catalyst composite having the rearranged electronic structure may be increased in the electron transfer efficiency, in which the electrons are transferred from metal phosphide to the MXene support.

In this case, metal phosphide may include one or more selected from the group consisting of nickel phosphide, iron phosphide, titanium phosphide, manganese phosphide, copper phosphide, molybdenum phosphide and cobalt phosphide.

Metal phosphide is not limited to the foregoing examples as long as it contains the transition metal and phosphorus.

Further, according to the disclosure, metal phosphide contained in the electrochemical catalyst composite by 30 wt % to 40 wt % relative to the total weight of the electrochemical catalyst composite.

In this case, if the content of metal phosphide is less than 30 wt % relative to the total weight of the electrochemical catalyst composite, the active points for the HER are reduced, thereby lowering an efficiency. On the other hand, if the content is more than 40 wt %, metal phosphide covers the MXene support, thereby lowering the reaction efficiency. Thus, metal phosphide may be contained by 30 wt % to 40 wt %.

Below, the disclosure will be described in more detail with reference to production examples and experimental examples. These production examples and experimental examples are for illustrative purpose only, and thus the scope of the disclosure is not limited by these production examples and experimental examples.

### Production Example 1: Production of MXene with Surface Defects

First, to produce a MXene (Ti₃C₂Tₓ) material by selectively etching out an Al layer from a MAX (Ti₃AlC₂) phase material, i.e., a raw material of a MXene, 1.0 g of MAX powder was slowly added to 10 mL of 48% HF solution, and then continuously agitated at 50° C. for 36 hours, thereby selectively etching out the Al layer from the inside of the MAX material.

In this case, a solution obtained by dispersing LiF in HCl or an HF solution may be used as an etching solution.

Next, the solution obtained after the etching was subjected to centrifugation (at 10,000 rpm for 10 minutes) and washing with deionized water.

In this case, the centrifugation was carried out until the pH of the aqueous solution in an upper layer of the settled MXene reached 6. After obtaining neutralized MXene slurry, the MXene slurry is immersed in liquid nitrogen to be completely frozen, and then freeze-dried to obtain the MXene having a multilayered structure in the form of black powder.

Next, for the process of forming the defects in the MXene, 100 mg of MXene having the multilayered structure was dispersed through the ultrasonic process in 10 mL of the acidic aqueous solution (mixture of 40% H₂SO₄ and 20% HNO₃ by volume) for 30 minutes.

Next, an acid in the MXene slurry was washed through a polyvinylidene fluoride (PVDF) membrane and the MXene material was filtered.

Next, a filtering process based on redispersing in deionized water was performed several times until the pH of dispersion solution reached 6.

Next, the filtered MXene was redispersed in DMSO, and subjected to the ultrasonic process for 36 hours under Ar gas atmosphere.

Next, the obtained dispersed acidic aqueous solution was centrifuged (at 3500 rpm for 1 hour) and freeze-dried, thereby preparing the MXene with the surface defects of the active points.

Production example 2: Electrochemical catalyst composite with Ni₂P@MXene structure

First, 200 mg of MXene with the surface defects prepared in the production example 1 and 200 mg of Ni(acac)₂ were put together into a three-necked flask, and 25.6 mL of oleylamine solution and 18 mL of octadecene solution were added and agitated to prepare a mixture.

In this case, the mixture was heated up to 120° C. by raising temperature by 10° C. per minute while being agitated, and the inside of the flask was vacuumized by a pump to remove residual moisture and evaporated impurities and maintained for 30 minutes.

Next, the inside of the flask was filled with Ar gas and 2 mL of tri-n-octylphosphine was injected from above the flask.

In this case, Ar gas and tri-n-octylphosphine were heated up to 320° C. by the same method as the foregoing temperature raising process, reacted for 2 hours, and then cooled slowly until they reached room temperature.

Next, the obtained black precipitate was centrifuged (at 10,000 rpm for 10 minutes) to remove a residual solution, and then a hexane/ethanol solution (1:3 by volume) for material washing was added to perform the redispersion based on the ultrasonic process and the centrifugation (at 10,000 rpm for 10 minutes) three times, thereby removing residual surfactants and organic solvents.

Next, the same washing process was performed with a hexane solution, and then the residual solution is removed so that the electrochemical catalyst composite (Ni₂P@MXene), in which metal phosphide and the MXene support are heterogeneously bonded, can be produced by drying in a vacuum oven at room temperature for 24 hours.

### Comparative Example: Ni₂P+MXene

100 mg of Ni₂P material and 200 mg of MXene material with the surface defects prepared in the production example 1 were physically mixed.

### Experimental Example1: Examination of Electrochemical Catalyst Composite Synthesis

The surface properties of the electrochemical catalyst composite will be described with reference to FIGS. 3 to 9.

FIG. 3 shows a scanning electron microscopy (SEM) image of an electrochemical catalyst composite according to an embodiment of the disclosure.

Referring to FIG. 3,(a) and (b) show that spherical Ni₂P is formed on a MXene nanosheet, and (c) shows that the Ni₂P material prevents the MXene from an overlapping phenomenon due to the van der Waals force.

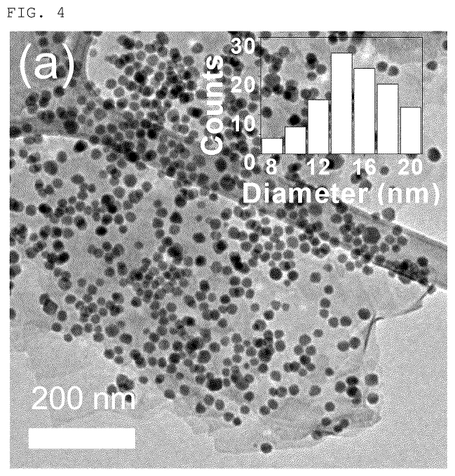

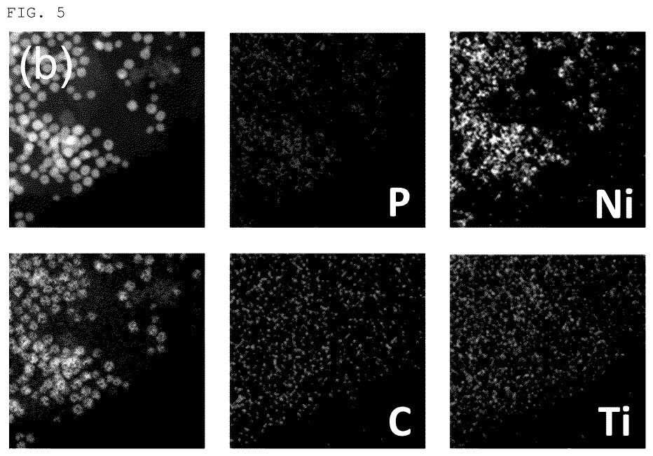

FIG. 4 shows a low-magnification transmission electron microscopy (TEM)image of an electrochemical catalyst composite according to an embodiment of the disclosure.

Referring to FIG. 4, the electrochemical catalyst composites according to an embodiment of the disclosure, i.e., Ni₂P particles having an average diameter of about 14 nm are evenly distributed on the MXene.

FIG. 5 shows high-angle annular dark field scanning transmission electron microscopy (HAADF-STEM) images of an electrochemical catalyst composite according to an embodiment of the disclosure and elemental energy dispersive spectroscopy (EDS) mapping images of P, Ni, C, and Ti.

Referring to FIG. 5, the presence of P, Ni, C, and Ti elements is examined through the HADDF-STEM images, and it is thus examined that the electrochemical catalyst composite (Ni₂P@MXene) according to an embodiment of the disclosure is successfully synthesized.

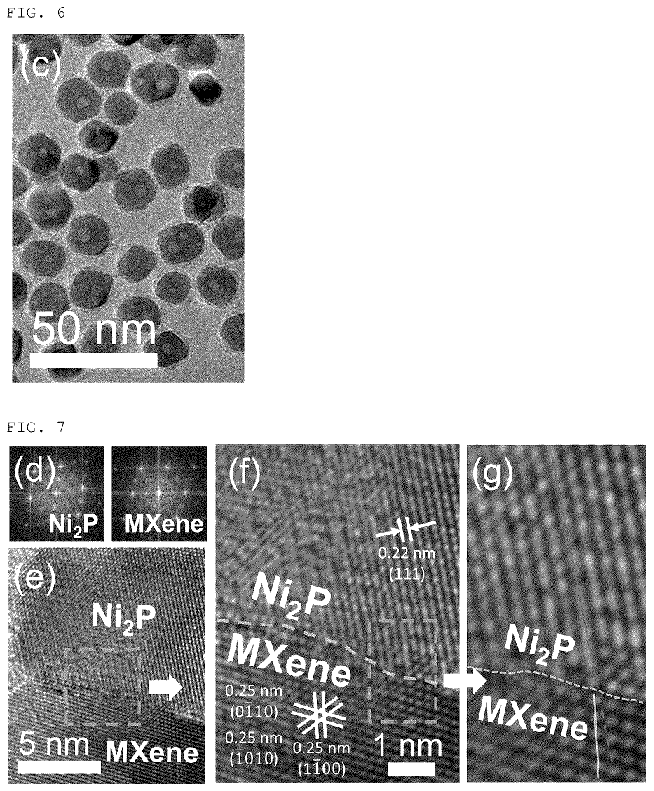

FIG. 6 shows a TEM image where Ni₂P is produced on the MXene of the electrochemical catalyst composite according to an embodiment of the disclosure.

Referring to FIG. 6, it is examined that Ni₂P particles with hollow centers are formed.

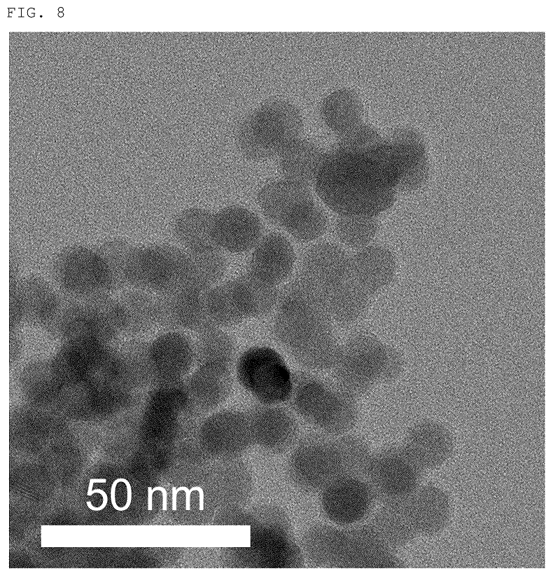

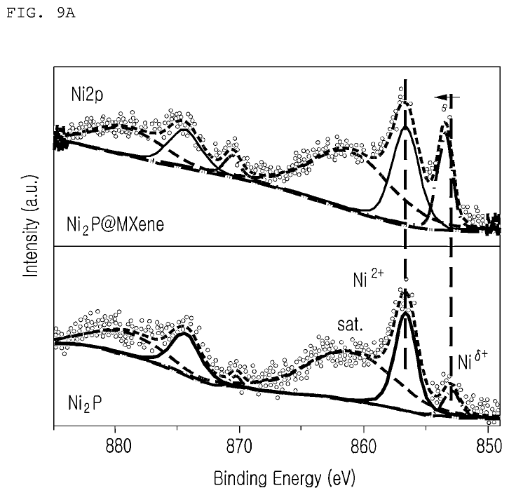

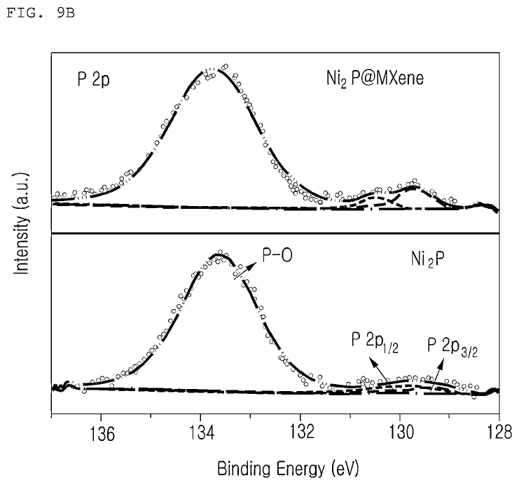

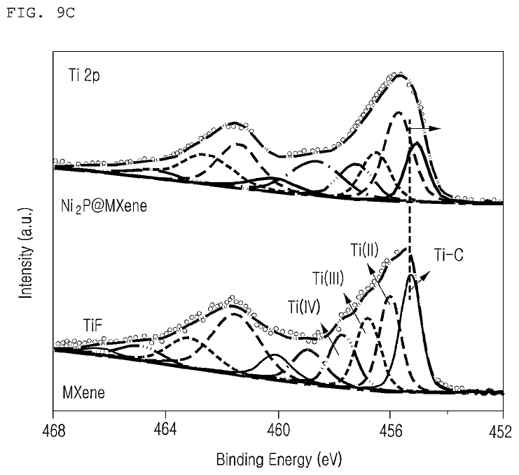

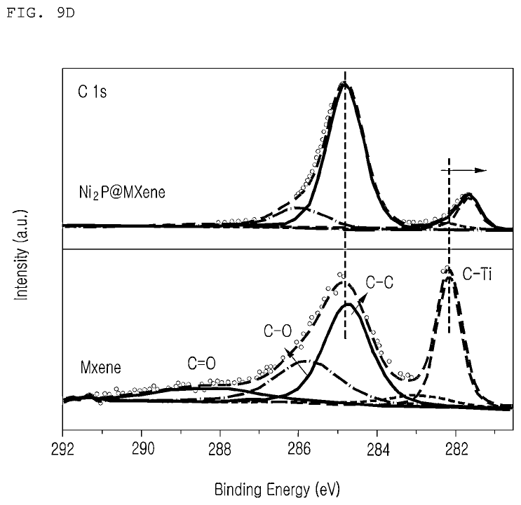

FIG. 7 shows fast Fourier transformation (FFT) and TEM images of an electrochemical catalyst composite according to an embodiment of the disclosure.

Referring to FIG. 7, based on TEM data showing that that crystals formed on a material interface are different in a growth direction, it is examined that strain is formed.

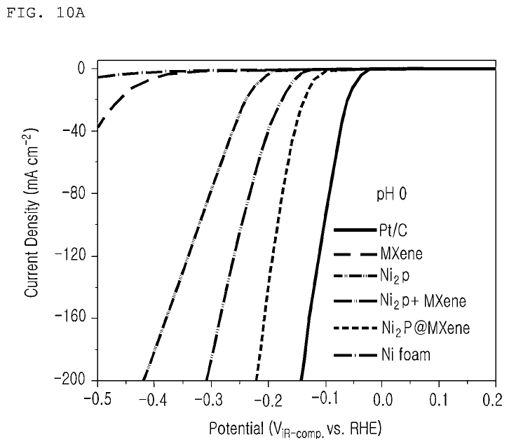

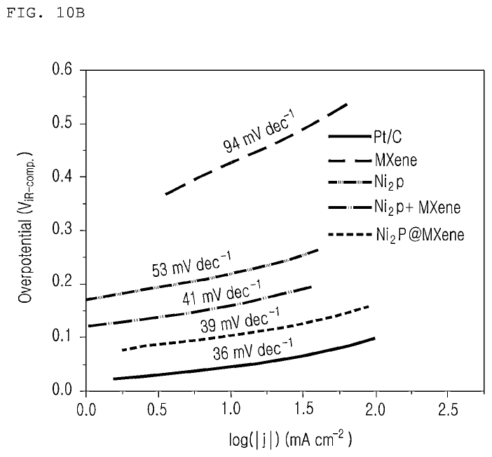

On the other hand, FIG. 8 shows a TEM image of a Ni₂P material.

Referring to FIG. 8, as a result from analyzing the TEM image of commercial Ni₂P, it is examined that the strain present on the interface causes Ni₂P with the hollow center to be formed.

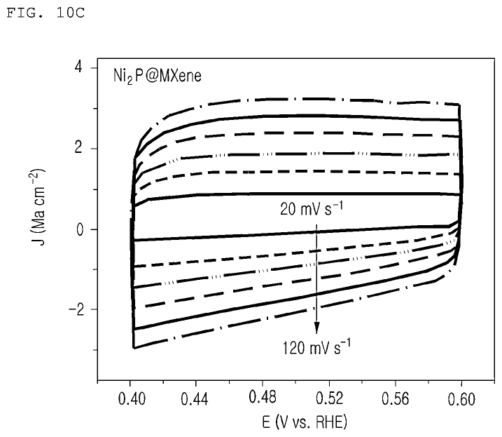

FIG. 9 shows X-ray photoelectron spectroscopy (XPS) spectra of Ni₂P, MXene, and electrochemical catalyst composite (Ni₂P@MXene) materials.

Referring to FIG. 9, FIG. 9A shows that a signal of Ni^{δ+} (853.4 eV) corresponding to a Ni—P bond of Ni₂P is positively shifted in the electrochemical catalyst composite (Ni₂P@MXene).

FIG. 9B shows that a signal corresponding to P^{δ} (˜130 eV) is stronger than that of the conventional Ni₂P. Further, this means that a metal-phosphorus (Me-P) bond has increased, electric charges have been transferred from Ni₂P to the MXene through the chemical bond between Ni₂P and the MXene, and the electronic structure of the catalyst material has changed through the charge rearrangement. In addition, FIGS. 9C and 9D show that signals corresponding to Ti(I) are negatively shifted as the electric charges are transferred from Ni₂P to the MXene.

Experimental example 2: Electrochemical performance examination of electrochemical catalyst composites.

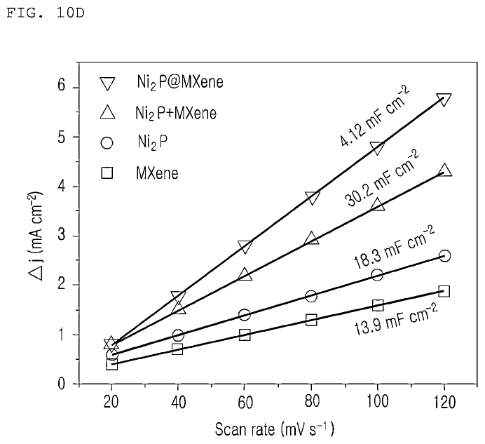

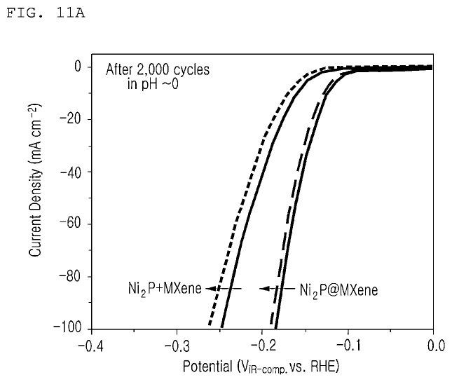

FIG. 10 shows graphs of electrochemical performances of electrochemical catalyst composites.

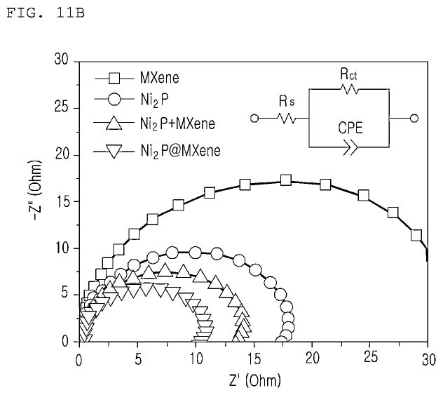

FIG. 11 shows an electrochemical performance change graph and electrochemical impedance experimental data after an electrochemical catalyst composite is subjected to 2,000 cyclic voltammetry operations.

In this experimental example, 0.5 M H₂SO₄ (pH 0) solution was used as an electrolyte to test the electrochemical catalyst performance, a three-electrode system was used to test HER catalyst performance, and 4 mg of catalyst material was mixed with 30 uL of nation and 1 mL of water/IPA solution (1:1 by volume) to make ink, thereby using the ink dropped on nickel foam as a working electrode, using an Ag/AgCl electrode as a reference electrode, and using a graphite rod electrode as a counter electrode.

FIG. 10A shows that a low overvoltage of 123.6 mV was achieved with respect to 10 mA/cm². Further, FIG. 10B shows that the electrochemical catalyst composites have the Tafel slope of 39 mV/dec, which is similar to that of the Pt/C catalyst based on precious metals.

Referring to FIGS. 10C and 10D, as a result from obtaining the double layer capacitances of the electrochemical catalyst composite (Ni₂P@MXene) through the cyclic voltammetry, it is examined that the double layer capacitance of the electrochemical catalyst composite (Ni₂P@MXene) is 1.3 times greater than that of the comparative example (Ni₂P+MXene catalyst) and greater than 2.4 times than that of Ni₂P. This means that the electrochemical catalyst composite (Ni₂P@MXene) has a larger surface active site than those of other comparative catalysts.

Further, referring to FIG. 11A, the comparative example (Ni₂P+MXene) material and the electrochemical catalyst composite (Ni₂P@MXene) material according to an embodiment of the disclosure were subjected to 2,000 cyclic voltammetry operations to test their performances, and it is thus examined that the physically mixed materials had poor performance but the electrochemical catalyst composite (Ni₂P@MXene) material was driven stably.

FIG. 11B shows electrochemical impedance measurement Nyquist plot data for each catalyst material. The electrochemical catalyst composite (Ni₂P@MXene) had a charge transfer resistance of 14Q lower than those of other catalyst materials, and it is thus examined that the electrochemical catalyst composite (Ni₂P@MXene) were improved in electrical properties.

According to an embodiment of the disclosure, the electrochemical catalyst composite is a hybrid material having a heterojunction structure between metal phosphide with controlled crystal strain and the MXene, in which metal phosphide produced by a synergy effect between the two materials prevents an overlapping phenomenon caused by the van der Waals force of the two-dimensional MXene material and increases a surface area, thereby having an effect on increasing reaction active points.

Further, metal phosphide material with the controlled strain causes an electron structure of an element in the MXene support to be rearranged, thereby inducing change in an electrical structure.

In addition, the MXene support combined with metal phosphide having the controlled strain promotes a hydrogen generation reaction, thereby having effects on enhancing the electrochemical performance and improving the electrical properties and stability of the material.

The effects of the disclosure are not limited to the forementioned effects, but should be understood to include all other effects inferable from the configuration of the disclosure described in the detailed description or claims.

The foregoing descriptions of the disclosure are for illustrative purposes only, and it will be appreciated by a person having ordinary knowledge in the art, to which the disclosure pertains, that change to other specific forms can be made easily without departing from the technical spirit or essential features of the disclosure. Therefore, the foregoing embodiments should be understood as illustrative and not restrictive in all aspects. For example, each component described in a united form may be implemented as divided, and similarly, the components described in a divisional form may also implemented as united.

The scope of the disclosure is defined by the appended claims, and all changes or modifications in the meaning and the scope of the appended claims and their equivalents should be construed as falling within the scope of the disclosure.

### DESCRIPTION OF REFERENCE NUMERALS

100: MXene support
200: metal phosphide nanoparticles

What is claimed is:

1. An electrochemical catalyst composite comprising:
a two-dimensional MXene support with surface defects; and
metal phosphide nanoparticles located at a surface defect site of the two-dimensional MXene support and having controlled crystal strain.

2. The electrochemical catalyst composite of claim 1, wherein the two-dimensional MXene support with the surface defects and the metal phosphide nanoparticles are heterogeneously bonded.

3. The electrochemical catalyst composite of claim 1, wherein the two-dimensional MXene support with the surface defects comprises metal carbide MXenes represented by the following chemical formula 1:
M₃C₂Tₓ [Chemical formula 1]
where M is one or more metals selected from a group consisting of Ti, V, Cr, Zr, Nb, Mo, Hf, Ta and Sc, T is a functional group of F, O or OH, and x is a real number greater than 0.

4. The electrochemical catalyst composite of claim 1, wherein the two-dimensional MXene support are subjected to an ultrasonic dispersion process in an acidic solution and an organic solution to have the surface defects.

5. The electrochemical catalyst composite of claim 1, wherein the metal phosphide comprises one or more selected from the group consisting of nickel phosphide, iron phosphide, titanium phosphide, manganese phosphide, copper phosphide, molybdenum phosphide, and cobalt phosphide.

6. The electrochemical catalyst composite of claim 1, wherein the metal phosphide is contained by 30 wt % to 40 wt % relative to a total weight of the electrochemical catalyst composite.

7. The electrochemical catalyst composite of claim 1, wherein electric charges are transferred from the metal phosphide nanoparticles to the MXene support through a chemical bond between the MXene support and the metal phosphide nanoparticles, and an electronic structure is changed through charge rearrangement to increase a metal-phosphorus bond and positively shift a bonding peak on X-ray photoelectron spectroscopy (XPS).

8. The electrochemical catalyst composite of claim 1, wherein electric charges are transferred from the metal phosphide nanoparticles to the MXene support through a chemical bond between the MXene support and the metal phosphide nanoparticles, and an electronic structure is changed through charge rearrangement to negatively shift a peak corresponding to Ti (1) on X-ray photoelectron spectroscopy (XPS).

9. A method of producing an electrochemical catalyst composite, the method comprising:
preparing a two-dimensional MXene support by selectively removing an aluminum layer from a two-dimensional MAX material;
forming defects on a surface of the two-dimensional MXene support by subjecting the MXene support to an ultrasonic dispersion process; and
producing the electrochemical catalyst composite by forming metal phosphide nanoparticles, of which crystal strain is controlled, in a surface defect site of the MXene support through heteronuclear growth based on a hot injection method in the two-dimensional MXene support with the surface defects.

10. The electrochemical catalyst composite of claim 9, wherein the two-dimensional MAX material in the preparing the two-dimensional MXene support comprises materials represented by the following chemical formula 2:
Mₙ₊₁AXₙ [Chemical formula 2]
where M is one or more metals selected from a group consisting of Ti, V, Cr, Zr, Nb, Mo, Hf, Ta and Sc, A is one or more metals selected from a group consisting of Al, Si, P, S, Ga, Ge, As, Cd, In, Sn, Ti and Pb, X is C or N, and n is a rear number greater than 1.

11. The electrochemical catalyst composite of claim 9, wherein the two-dimensional MXene support in the preparing the two-dimensional MXene support comprises metal carbide MXenes represented by the following chemical formula 1:
M₃C₂Tₓ [Chemical formula 1]
where M is one or more metals selected from a group consisting of Ti, V, Cr, Zr, Nb, Mo, Hf, Ta and Sc, T is a functional group of F, O or OH, and x is a real number greater than 0.

12. The electrochemical catalyst composite of claim 9, wherein the forming the defects on the surface of the MXene support comprises performing an ultrasonic dispersion process in two stages in an acidic solution and an organic solvent.
